(19) United States
(12) Patent Application Publication
(10) Pub. No.: US 2026/0217542 A1
(43) Pub. Date: Jul. 30, 2026

(54) PROCESS FOR TREATING CHAR FROM RECYCLED PLASTICS

(71) Applicant: VERSALIS S.P.A., San Donato Milanese (MI) (IT)

(72) Inventors: Nicola VECCHINI, Mantova (MN) (IT); Armando GALEOTTI, Mantova (MN) (IT); Cecilia GRADELLA, Mantova (MN) (IT); Michela SIGNORETTO, Venezia (VE) (IT); Lilia LONGO, Venezia (VE) (IT)

(21) Appl. No.: 19/143,264

(22) PCT Filed: Dec. 14, 2023
(86) PCT No.: PCT/IB2023/062661

§ 371 Date: Jun. 25, 2025

(30) Foreign Application Priority Data
Dec. 27, 2022 (IT) 102022000026886

(51) Int. Cl. C01B 32/40; C10J 3/62

(52) U.S. Cl. CPC C01B 32/40; C10J 3/62; C10J 2300/094; C10J 2300/0969

(57) ABSTRACT

A process for recovering carbon contained in a char (solid carbonaceous residue) from a pyrolysis of mixed plastic waste or secondary raw material obtained from recycling and/or treatment of plastic wastes includes:
heating the char in a gasification reactor and in the presence of carbon dioxide to reach a given temperature in a range lower than 950° C. and higher than 600° C.;
continue heating the char in this temperature range, in the presence of CO₂, for a given residence time of char in the reactor producing an outflow gas stream (effluent) including CO in addition to unreacted CO₂, and possibly H₂,
and sending at least a part of the gas stream (effluent) leaving the reactor including CO, unreacted CO₂, and optionally H₂, to at least one subsequent operating unit selected from a unit for separating CO from CO₂, a direct use unit of said the outflow stream or to a storage unit.

### CROSS-REFERENCE TO RELATED APPLICATIONS

This application is a 35 U.S.C. § 371 National Stage patent application of no. PCT/IB2023/062661, filed on 14 Dec. 2023, which claims the benefit of Italian patent application no. 102022000026886, filed on 27 Dec. 2022, the disclosures of which are incorporated herein by reference in their entirety.

### TECHNICAL FIELD

The present disclosure relates to a method for treating a “char” (solid carbonaceous residue) from the pyrolysis of mixed plastic waste (a mixture of two, three or even more than three recycled plastics differing in chemical nature and/or physical and/or structural characteristics, e.g. density, presence of branching, crystallinity, etc.) to maximise the recovery of material from said pyrolysis process.

More particularly, the present disclosure relates to a method for treating char from thermal and/or catalytic pyrolysis of mixed plastic waste, or from pyrolysis of mixed plastics as defined above, using CO₂, preferably CO₂ recovered from the same pyrolysis process, or from capturing CO₂ from processes that produce it (other industrial/civil cycles), in order to produce CO, and possibly synthesis gas (mixture containing mainly CO, H₂ and CH₄, CO₂ in smaller amounts).

Still more particularly, the present disclosure relates to a method for recovering carbon from “char” obtained from pyrolysis of mixed plastics or mixed plastic waste as defined above, by producing CO, and possibly synthesis gas, at temperatures below 950° C., with a high recovery of carbon from char, e.g. close to 100% by weight, improving the recovery of material from mixed plastic waste and/or mixed plastics as defined above.

### BACKGROUND

As known, the recovery of material from mixed plastic waste that cannot be mechanically recycled is mainly carried out through two different chemical recycling methods, industrially applicable, that allow the polymeric material to be returned to its original state as a monomer or as a precursor.

A first method relates to the direct, high-temperature gasification of this plastic waste by means of a gasifying agent such as H₂O, O₂/air, CO₂ to produce syngas; a second method relates to the thermal and/or catalytic pyrolysis of said polymeric materials.

The choice of one method rather than the other for recycling plastics mainly depends on what main product is to be obtained: syngas to be used in the Fisher Tropsch reaction and other subsequent reactions to produce monomers in the case of direct gasification of plastics; a hydrocarbon oil to be sent to cracking to obtain material that will in turn feed the polymer production chain in the case of pyrolysis of plastics.

Pyrolysis is a preferred recovery method in plastic recycling as it does not produce tar (a dark and viscous liquid) and takes place at lower temperatures (around 500-600° C.) than direct gasification, which on the other hand takes place at temperatures above 600° C., and it is generally associated with the production of tar while leading to the formation of syngas as main product; however, in this pyrolysis process, a non-negligible amount of by-product, “char”, to be placed on the market, is produced, which is generally around 5% by weight, but it can be as much as 20% by weight, compared to the hydrocarbon oil produced.

There are many aspects that make it difficult to manage this by-product in the pyrolysis process.

The physical state of char is that of a fine powder, which makes it difficult to handle it: to better enable subsequent handling thereof, char powder must be subjected to compaction and granulation operations, which are very often carried out using binding agents. Powders in finely divided form and under certain conditions may also have pyrophoricity/explosivity characteristics.

In addition, char from mixed plastics mainly consists of a part formed of carbon and hydrogen and of a part which is inorganic (ash) and is formed by oxides and/or carbonates of various metals such as Ca, Na, K, Fe, Si, Al and others (e.g. titanium, zinc, chromium, manganese, copper, nickel), wherein the part composed of carbon is highly variable since the chemical composition of the mixed plastic waste used in pyrolysis is extremely variable, as well as the pyrolysis process which can be carried out in quite different ways.

Thus, as the chemical composition of char from the pyrolysis of mixed plastics is very variable, the reuse of such char as a raw material has limited applications: a first reuse is as an inert material in the production of activated carbons or as a support, also functionalised, for catalysts due to the high surface area and pore volume, particularly in the case of Bio-Char (by-products of the thermal pyrolysis of biomasses, e.g. lignite).

To the best of the Applicant's knowledge, a second reuse of char from pyrolysis of mixed plastics is in the cement or steel sector, due to both its highly variable composition and high content of inorganic compounds (ash).

The aforementioned uses are limited and thus most of the char resulting from the pyrolysis of mixed plastics has very limited uses, and it is therefore managed as a waste in case the market is saturated and does not take it back.

In all of the above cases, the carbon content of the pyrolysis char actually represents a loss of material in the process of recycling mixed plastic waste by pyrolysis, and this loss leads to a decrease of the final yield (i.e. percentage by weight of the hydrocarbon oil and gas produced compared to the total weight of all products obtained including by-products such as char) of the pyrolysis process; this phenomenon is more emphasised the higher the carbon content in the char and the higher the amount of char produced in the pyrolysis process.

### SUMMARY

The Applicant therefore set out the aim to find ways to overcome the problems described above mainly related to the handling of char from the pyrolysis of mixed plastic waste and its limited reuse, by recovering the char, or at least most of it, produced by the pyrolysis of mixed plastics and, at the same time, recovering the CO₂ (all or part) produced in the pyrolysis process.

The Applicant has now surprisingly found that it is possible to largely recover the char produced from the pyrolysis of mixed plastics or mixed plastic waste by exploiting, in a specific temperature range, a reaction known as the “Boudouard Equilibrium” which has made it possible to use char from the pyrolysis of mixed plastic waste as raw material, regardless of the variability in the composition of said mixed plastic waste and consequently in the composition of said char, thereby solving the problems previously set forth regarding the management and/or handling of char.

The Boudouard equilibrium or reaction, is a disproportionation reaction between carbon dioxide, carbon monoxide and carbon (e.g. graphite) that was studied in 1905 by the French chemist Octave Leopold Boudouard (2CO↔CO₂+C). At present, it is known, particularly from the literature, to submit to the aforementioned Boudouard reaction certain specific chars, such e.g. as bio-char, char obtained by pyrolysis from tyres, and char from certain limited mixtures of individual plastics (ternary mixtures at most), which do not suffer from the drawback of having a considerably variable composition as mixed plastic waste does.

Some relevant documents of the prior art are reported below.

The article “CO₂ Gasification Reactivity and Syngas Production of Greek Lignite Coal and Ex-Situ Produced Chars under Non-Isothermal and Isothermal Conditions”—Energies 2022,15, 679, discloses studies carried out on the transformation of coal from lignite into syngas containing CO, H₂, CH₄, CO₂, wherein the pyrolysis of said coal (Greek lignin) and gasification in the presence of CO₂ of the biochar (biomass char) obtained from lignite at various temperatures is provided. Pyrolysis is carried out on lignite in order to remove functional groups weakly bound in the lignin to obtain a better solid fuel for gasification. In particular, the article outlines the syngas yields that can be obtained under various conditions from these pyrolyzed materials (biochar) at 300° C., 500° C. and 800° C. compared to non-pyrolyzed raw lignite. The material recovery yield (understood as reacted carbon), determined by thermogravimetric analysis, varies from about 48 wt. % to about 84 wt. % in the temperature range from 650° C. to 920° C., depending on the type of biochar. The article does not provide or disclose any applicable process description for the char from pyrolysis of mixed plastics, which, due to their compositional nature, are not comparable to lignite pyrolysis residues.

The ENEA report RSE/2009/187 discloses the results of the thermogravimetric analysis carried out on some samples of fossil fuel coal. The reactivity towards CO₂ through the Boudouard reaction at 900° C., 1000° C., 1100° C. is also assessed. The report therefore does not investigate the behaviour of a pyrolysis residue (char), in particular a residue from the pyrolysis of mixed plastic waste.

The article “Waste-tyre pyrolysis and gasification via the reverse Boudouard reaction: derivation of empirical kinetics from TGA data”—Thermochimica Acta 708 (2022) 179104, discloses kinetic studies on the pyrolysis of tyres and on the gasification of char resulting from them via the Boudouard reaction in order to produce a syngas. Good material recovery yields (around 85% by weight) on char gasification are obtained at temperatures of 900° C. and above, while yields are around 70-75% by weight at around 850° C. However, char obtained from tyre pyrolysis and subjected to gasification according to the Boudouard reaction implies expensive subsequent purification operations on the gas obtained, which always contains toxic sulphur compounds due to the high sulphur content in char: for this reason, it is of little industrial interest to recover material from this type of char via this route. In this case also no process is described nor disclosed to be applied to char from pyrolysis of mixed plastics.

The article “CO₂-assisted gasification of polyethylene terephthalate with focus on syngas evolution and solid yield”—Applied Energy 276 (2020) 115508, reports results on the study of direct gasification of PET using carbon dioxide; it thus uses only one type of plastic and states that, due to the absence of ash (which is present in char from mixed plastic waste, even if in varying composition) and the high carbon content, char from PET is a promising material as a precursor to carbon materials. The article therefore relates to a direct gasification of a polymer and not a gasification of a pyrolysis residue of mixed plastics with a widely varying composition and high ash content.

The article “A Critical Review of SCWG in the Context of Available Gasification Technologies for Plastic Waste”—Appl. Sci. 2020, 10, 6307″ describes the process of direct gasification of various materials with water under supercritical conditions, including also plastic waste. It therefore does not describe the CO₂ gasification of a char from mixed plastics pyrolysis. Furthermore, one of the problems of direct gasification of various plastic materials is the production of TAR and pitch, which are very viscous products and hence represent a problem as they soil the plant and are hard to recover.

The article “Performance Prediction of Waste Polyethylene Gasification Using CO₂ in a Bubbling Fluidised Bed: A Modelling Study”—Chem. Biochem. Eng. Q., 32 (3) 349-358 (2018) describes a simulation carried out through the ASPEN PLUS software, in which waste of polyethylene alone is gasified in a fluidised reactor. Gasification is carried out in the presence of CO₂. The type of waste is completely different from the pyrolysis residue of mixed plastics in that it contains only polyethylene and not also mixed plastics. In this direct gasification, all the polyethylene is transformed into syngas from which it is necessary to restart to get to the polymer chain. It therefore does not describe the CO₂ gasification of a char from mixed plastics pyrolysis.

M. V. Gil et al “Intrinsic char reactivity of plastic waste (PET) during CO₂ gasification”, Fuel Processing Technology, ELSEVIER BV, NL, vol. 91, no. 11, 1 Nov. 2010, pages 1776-1781, discloses the partial CO₂ gasification of a PET pyrolysis residue containing no inorganic part, operating at temperature of at least 925° C. until 1125° C.: the aim of the study is to investigate how porosity of samples affects the gasification kinetics at those temperature whereas no investigation is carried out at lower temperatures for a char derived from mixed plastic pyrolysis containing also an inorganic part.

WO2021/163110 discloses the partial oxidation of a pyrolysis residue of plastic with oxygen enriched oxidizing agent wherein CO₂ can optionally be present as carrier gas in the oxygen enriched oxidizing agent to propel the feedstock in the reaction zone: the aim is thus to obtain CO by partial oxidation wherein oxygen is the reactant. The use of partial oxidation to obtain CO as main product shows the drawback of requiring the strict control that the moles of oxygen as reactant be half, or less than half, of those of the carbon contained in the residue in order to maximize the conversion of the carbon into CO, and avoid the production of CO₂ which starts when the moles of oxygen are more than half of those of the carbon contained in the residue and increase until the moles of oxygen are the same or more than of the carbon moles contained in the residue; at this point the production of CO₂ is maximum and the CO production is practically zero (total oxidation).

The present disclosure therefore provides an industrially applicable process for the reuse, as a raw material, of char from pyrolysis processes of mixed plastic waste differing in chemical nature and/or in physical characteristics, and/or in structure (e.g. density, presence of branching, crystallinity, etc.), generally mixed plastic waste containing more than three different plastics, and/or for the recovery of carbonaceous material from said char, which allows to:
simplify and make operations in the pyrolysis process cost-effective by eliminating the operation of granulating and consolidating the char powder leaving the pyrolysis plant; and/or
recover at least a large part of the carbon present in the char by transforming it into a useful product to produce raw material again from waste plastics, increasing the overall yield in term of recovered material with respect a perspective of circularity of the pyrolysis process of mixed plastic waste; and/or
possibly use one or more additional materials produced in the pyrolysis process, e.g. potassium salts, CO₂, further increasing the overall material yield of the pyrolysis process of mixed plastic waste, or other material produced in other production processes, including civil uses, to increase process circularity.

Another feature of the present disclosure is to define and develop a process for treating char from pyrolysis of mixed plastic materials using CO₂ that maximises the conversion of the carbon present in the char residue of the pyrolysis process and simultaneously enables the recovery of the CO₂ produced. This process is particularly useful when applied to a pyrolysis plant of mixed plastics as it allows to increase the yield of the plant and to reduce the powder formed as residue to be handled.

### DETAILED DESCRIPTION OF THE DISCLOSURE

One or more of these features is achieved by providing an appropriate process described in the present application.

The Applicant has in fact found a particular method for reusing char from thermal and/or catalytic pyrolysis of mixed plastic waste, and possibly also the carbon dioxide produced by the thermal and/or catalytic pyrolysis, or the CO₂ produced by other industrial/civil cycles. The method the Applicant has found makes it possible to solve one or more of the aforesaid features and solves the technical problem reported above by the treatment of said char with CO₂ in a specific temperature range with the consequent production of CO by means of Boudouard's reaction, according to what is claimed in the appended claims.

To the best of the Applicant's knowledge, it is not presently known a process for the pyrolysis of mixed plastic waste, in particular mixtures containing more than three plastic types differing in terms of chemical nature and/or physical and structural characteristics, (e.g. density, presence of branching, crystallinity, etc.), wherein there is also provided the treatment of the respective char with CO₂ for valorisation thereof as a raw material in order to maximise the yield of the pyrolysis process by producing CO, thus avoiding the loss of raw material contained in the char if used as a reducing agent and/or in industrial applications, or possibly disposed of as waste in case it cannot be reused.

A first feature of the present disclosure is thus to provide a process for recovering the carbon contained in a char (solid carbonaceous residue) from thermal and/or catalytic pyrolysis of mixed plastic waste or secondary raw material which is the end product of the recycling and/or treatment of plastic wastes (and thus obtained from the recycle and/or treatment of plastic wastes), or from a char from pyrolysis of mixed plastics, through the production of CO, and possibly synthesis gas, said process comprising the following steps:
(A) heating said char in a gasification reactor and in the presence of carbon dioxide to reach a prefixed temperature comprised in a range lower than 950° C. and higher than 600° C., preferably lower than or equal to 900° C., more preferably lower than or equal to 850° C.;
(B) continue heating said char in the temperature range, preferably in the range from 750° C. to 850° C., in the presence of CO₂, for a prefixed residence time of said char in said reactor producing an outflow gas stream (effluent) comprising CO in addition to unreacted CO₂, and possibly H₂,
(C) sending at least a part of the gas stream (effluent) leaving the reactor comprising CO, unreacted CO₂, and optionally H₂, to at least one subsequent operating unit selected from a unit for separating CO from CO₂, a direct use unit of said outflow stream or to a storage unit.

The mixed plastic waste from which the char used in the present disclosure derives via pyrolysis comprises, or consist essentially of, a mixture of two, three or even more than three recycled plastics differing in chemical nature and/or physical and/or structural characteristics, e.g., density, presence of branching, crystallinity, etc.

Moreover, the char that is originated from the pyrolysis of above-mentioned plastic waste also includes inorganic material (ashes) generally formed by oxides and/or carbonates of various metals such as Ca, Na, K, Fe, Si, Al and others (e.g. titanium, zinc, chromium, manganese, copper, nickel).

In step (A), the prefixed temperature is generally the one at which CO formation begins to be detected due to the gasification of the char by means of CO₂ which is the gasifying agent.

In step (B), the temperature is advantageously lower than or equal to 850° C. and higher than 600° C.

In a preferred embodiment, the char to be subjected to steps (A), (B) of the process according to the present disclosure is a char produced from a pyrolysis process of mixed plastic waste or secondary raw material obtained from the recycle and/or treatment of plastic wastes.

In one embodiment, step (C) provides to send only part of the outflow gas stream to at least one subsequent unit for separating CO from the CO₂: in this case it is furthermore preferred that the remaining part of the gas stream leaving the reactor is recycled in the gasification reactor, optionally supplemented with fresh replenishing CO₂.

In step (A), the CO₂ in the gasification reactor is the gasification/gasifying agent and it is the only reactant or the main reactant.

In step (A), the oxidation of the carbon contained in the char occurs by means of CO₂ as reactant (reverse Boudouard reaction) according to the following reaction

C+CO₂→2CO

The above reaction is completely different from the reaction of C+½O₂→CO (partial oxidation).

In said step (A), the CO₂ in the gasification reactor can either be a gas stream of pure CO₂ or be a gas stream containing CO₂ in a predominant amount compared to the total amount other gases that may be contained in the stream (hereinafter also referred to as carbon dioxide-based gas): when said gas stream containing CO₂ in predominant amounts also contains gaseous oxygen, the amounts of said oxygen are no greater than 5% by volume with respect to the total volume of the gas containing CO₂, and in any way in such amounts as to consider the gaseous oxygen as an impurity rather than a reactant.

Actually, in the process of the present disclosure the oxygen is an unwanted but tolerated substance, which is present like other substances as an impurity since the source of the CO₂ can be of different origins and the removal of such oxygen, as well as of other impurities, would be expensive for the present industrial process in order to obtain a stream of CO₂ with a negligible (or irrelevant, e.g. to less than 0.1 vol %) concentration of oxygen.

Said CO₂-Based Gas or CO₂-Based Gas Stream can be Preferably Selected from
a gas mainly containing CO₂, e.g. CO₂ of technical grade or containing CO₂ in amounts of 80-90% by volume, and one or more of other gases as impurity, e.g. O₂, N₂, in negligible amounts or in small amounts, e.g. in a total amount of less than 1% by volume; or
a gas mainly comprising CO₂, e.g. around 50%-70% by volume, and CO for the remainder;
a recycled gas comprising recycled CO₂ and CO, e.g. recycling of the gas leaving the gasification reactor.
—CO₂ or a stream of CO₂ obtained from the pyrolysis plant after a possible separation of CO₂ from other gases.

In a preferred embodiment, in step (A), non-pure CO₂ is used as it is contained in a gas stream containing CO₂ in a predominant amount relative to other gases contained in said stream, e.g. a CO₂ gas as defined above, or a CO₂-based stream, not containing N₂ and/or O₂ and/or other gases other than CO₂ and CO, which optionally may also contain CO in amounts smaller than CO₂.

In Step (A), Heating the Char can be Performed by Feeding into the Reactor
pure/substantially pure CO₂ which has been appropriately pre-heated; or the appropriately preheated CO₂-based gas;
or by heating the reactor externally or by using a combination of the two aforesaid modes (external heating of the reactor plus heated gas supply) or by other methods as described later.

In step (B), heating can be continued either by directly heating the reactor surface containing the char or by bringing the char into contact with a hot stream of CO₂-based gas, which is then fed to the reactor, or by using a combination of the two, or by other methods as described later.

### In Step (B) the CO₂ Present in the Reactor can be

a stream of fresh CO₂ (replenishing CO₂), or
the one which is present in a gas stream containing CO₂ in a predominant amount compared to other gases (also referred to herein as CO₂-based gas stream), or
a stream formed by a combination thereof.

### Such a CO₂-Based Gas Stream to be Used in Step (B) can be, for Example:

a part of the gas stream leaving said gasification reactor (effluent) containing unreacted CO₂ and CO, hereinafter also referred to as recycled stream; a stream of CO₂ obtained from the pyrolysis plant after possible separation of CO₂ from other gases.

In a preferred embodiment, in step (B) the CO₂ in the gasification reactor is the one contained in a recycled stream of a part of the gas leaving said gasification reactor, possibly combined with fresh replenishing CO₂: in this case, it is preferable that the step (C) further comprises subjecting the non-recycled part of the gas leaving the reactor to a separation step for separating CO and possibly H₂ from the remaining gas products including unreacted CO₂ present in said non-recycled part of the gas leaving the reactor.

In a preferred embodiment, the process for recovering the carbon of a char (solid carbonaceous residue) resulting from a thermal and/or catalytic pyrolysis of mixed plastic waste or secondary raw material obtained from the recycle and/or treatment of plastic wastes, or a pyrolysis char of mixed plastics, through the production of CO, and possibly synthesis gas, comprises the following steps:
(A) heating said char in a gasification reactor and in the presence of carbon dioxide to a prefixed temperature comprised in a range varying from 600° C. to 850° C., at which point CO generation begins to be detected;
(B) continue heating said char in the aforesaid temperature range, preferably in the range from 750° C. to 850° C., in said reactor, in the presence of CO₂, for a prefixed residence time of said char in said reactor, producing an outflow gas stream (effluent) comprising CO in addition to unreacted CO₂, and possibly H₂;
(C) sending at least a part of the gas stream leaving the reactor (effluent) comprising CO, unreacted CO₂, and possibly H₂, to at least one subsequent unit for separating CO from CO₂, and recirculating, into said gasification reactor in said step
(B), the other part of the effluent containing CO₂ and CO (not recirculated part), possibly combined with fresh replenishing CO₂.

The aforesaid preferred embodiment providing a partial recirculation of the effluent containing CO, CO₂ leaving the reactor and sending the part of the effluent not recirculated to the separator is advantageous in that the volumes to be sent to the separator to separate CO from CO₂ are small, in addition to the savings in heating the char as it is carried out by the gas stream entering the reactor.

The final product of said method of treating the char from pyrolysis of mixed plastic waste is thus represented, after the separation of CO₂ from CO, by
a gas mainly consisting of CO and optionally H₂ and
a solid residue consisting of inorganic compounds (hereinafter also referred to as inert or ash), usually carbonates and/or metal oxides that are present in mixed plastic waste and/or have been added in pyrolysis processes.

Examples of metals that may be present in the solid residue (as initially present in the char) are Ca, Ti, Na, K, Al, Si, and/or others e.g., zinc, chromium, manganese, copper, nickel, and combinations thereof.

The final gas obtained in step (C) after the separation of CO from CO₂ and which mainly consists of CO, and optionally H₂, can also be stored for subsequent use or sent directly to plants to produce other chemicals such as methanol or processes based on Fischer-Tropsch synthesis.

It is therefore possible with the process subject of the present application to recover most of the char by mass, regardless of the variability of the chemical composition of the char obtained from pyrolysis and/or the higher or lower ash content in said char: this is an indication that ash does not adversely affect carbon recovery.

It is also possible with the process subject of the present disclosure to reuse as raw material the carbon dioxide obtained from the upstream pyrolysis process (or from other processes) from which the char is derived, and to eliminate the treatment operation (granulation or pelleting) of the char leaving the pyrolysis plant.

In accordance with the present disclosure, the singular indefinite article, one, is meant to also include the meaning of at least one, unless otherwise specified.

In the present Application, unless otherwise indicated, percentages are to be understood as percentages by mass.

In accordance with the present disclosure, the term “Char” means any solid residue, generally, but not only, in powder form, resulting from the pyrolysis of mixed plastic waste or SRM “Secondary Raw Material” obtained from the recycling and/or treatment of plastic wastes of any nature and/or composition as defined herein below.

As said, the char from the pyrolysis of mixed plastic waste mainly consists of a part composed of Carbon and Hydrogen, and to a lesser extent Oxygen, Nitrogen and traces of Sulphur, and an inorganic part consisting of oxides and/or carbonates and oxides of various metals such as Ca, Na, K, Fe, Si, Al and/or other metals such as titanium, zinc, chromium, manganese, copper, nickel, where the content of inorganic compounds (ash) can reach a composition up to 70% by weight.

A typical composition of char from the pyrolysis of plastic waste contains carbon as low as 30% by weight, generally contains from 40 to 70% by weight of carbon as determined by the CHNS analytical method.

In accordance with the present disclosure, the term “mixed plastic waste” means the overall mixed plastic waste resulting from the sorting of municipal plastic waste, from the mechanical recycling of packaging and/or plastic parts of electrical and electronic equipment, from plastic material resulting from industrial post-consumer and automotive sectors, all characterised by extreme structural heterogeneity and chemical composition both in terms of types of polymers and inorganic additives that will form char ash and/or organic additives.

In accordance with the present disclosure, the term “Secondary Raw Material (SRM)” means material consisting of plastic processing scraps/waste or materials derived from the recovery and recycling of plastic material waste.

Preferably, the characteristics of said secondary raw material are those defined in, Italian Standard UNI 10667-18.

Generally, mixed plastic such as that in secondary raw material and mixed plastic waste may also contain non-plastic materials, such as paper (cellulose), but in much smaller amounts than the total plastic content. An example of a maximum cellulose (paper) content can be 12% by weight to the total weight of the plastic mixture.

Obviously, the above definitions do not include used tyre plastics, and therefore the char from pyrolysis used in the present disclosure is not a char from tyre pyrolysis which—as mentioned above—has a high sulphur content and which can lead to the formation of toxic sulphur compounds when gasified at the temperatures envisaged in the process of the disclosure.

The gasification reactor used in the process of the present disclosure comprises or preferably consists of a horizontal cylinder, although this is not constraining for the purposes of the present disclosure and other reactor forms may be provided, e.g. vertical fluidised bed cylinder.

Said gasification reactor is then generally equipped with stirring/mixing means and/or a fluidisation system, e.g. fluidised bed, for favouring contact of the entire solid mass (char) with the carbon dioxide.

In particular, the gasification reactor can be any fluidised bed reactor.

In a preferred embodiment, said gasification reactor contains a screw therein as stirring/mixing means that also allow the char to advance/move along the gasification reactor in the case of a continuous process.

The heating temperature of said char in the gasification reactor in said step (A) and/or (B) can advantageously be comprised between 700° C. and 950° C., more preferably between 700-750° C. and 900° C., even more preferably between 700-750° C. and 850° C.

CO₂ or CO₂-based gas is fed into the reactor preferably after heating. As it enters the reactor, said CO₂ and/or said CO₂-based gas can have a temperature comprised between 600° C. and 950° C., preferably between 700° C. and 950° C., more preferably between 700-750° C. and 900° C., even more preferably between 700-750° C. and 850° C.

The heating, which the char is subjected to in said gasification reactor in step (A) and/or (B), can be carried out by any internal and/or external heating method (external heating of the reactor) known to the skilled in the art and by any heating means, or by a combination of heating means, such as, for example, irradiation by direct flame, by convection with hot gases or flue gases, electric heating, by microwave, without thereby departing from the scope of the present disclosure.

In a preferred embodiment, said heating of said char from pyrolysis of mixed plastic waste is carried out indirectly by means of a heating fluid external to the reactor, e.g. fed into the reactor chamber, such as flue gases (HOT GASES) from heating furnace of the pyrolysis plant.

In another, and particularly more preferred embodiment, said heating is carried out by means of electrical resistances, e.g. arranged outside the reactor.

In an alternative embodiment, the heating of the char in the gasification reactor can be carried out by heating the gas comprising or predominantly formed of CO₂ entering the reactor.

The heating of pure CO₂ or the aforementioned gas comprising CO₂ as defined above to be fed into the gasification reactor can be carried out through a heating fluid in a heat exchange apparatus or through heating means, e.g. electrical resistances.

In an embodiment, the heating of said CO₂ or of said gas comprising CO₂ as defined above to be fed to the gasification reactor is carried out in an external heat exchange apparatus, preferably a shell and tube heat exchanger, operating at a temperature between 800° C. and 1100° C. preferably between 825° C. and 950° C., even more preferably at 850° C.

In a preferred embodiment, said CO₂ or said hot gas comprising CO₂ as defined above is heated outside said heat exchanger and counterflow fed to the solid (char) which is advanced/moved by the cochlea, sometimes referred as screw conveyor and/or auger and at the same time subjected to mixing so as to increase the heat supplied to the pyrogasifier, i.e. gasification reactor, for the gasification reaction and for favouring intimate contact of all the solid mass (char) with the hot gas.

In the aforesaid embodiment, any fluidised bed reactor can be used for the purpose: the screw/auger/cochlea reactor is preferred, in the arrangement with gas external heating, in addition to cylinder heating, even more preferred.

In a preferred arrangement, heating can be performed by means of electrical resistances.

The total pressure during the char gasification reaction-measured as the average of the gas stream pressure entering the reactor and the effluent pressure leaving the reactor—can be comprised between 0.2 bar (a) and 1.5 bar (a), preferably between 0.5 bar (a) and 1.2 bar (a), more preferably between 0.85 bar (a) and 1.05 bar (a).

The residence time of the char in the gasification reactor can be comprised between 0.5 and 10 h, preferably between 2 and 8 h, more preferably between 5 and 7 h.

Said residence time of the char in the reactor corresponds to the time taken by the char to leave the reactor once it has entered.

In the case of continuous char feeding, the residence time is set in such a way as to achieve a certain conversion, e.g. complete or substantially complete or partial, of the carbon contained in the char, in particular of the non-inert part of the char (i.e. the carbon in its non-salified form): this conversion is determined by performing CHNS analysis on both the initial char, entering the reactor, and the residual char leaving the reactor, in order to determine the difference thereof.

In the case of batch char feeding, the residence time is the time the char remains in the reactor until a decrease in the CO content in the effluent is observed at a constant total flow rate of CO₂ fed to the reactor.

The total amount of CO₂ fed to the gasification reactor (even in the case of fresh CO₂ plus CO₂ recycled from the process) is a function of the carbon content present in the char.

As already mentioned, the content of said carbon is generally measured using a standard analytical technique (CHNS elemental analysis, with temperatures up to 1100° C.).

It is understood that other techniques may be used to determine the carbon content without departing from the scope of the present disclosure and the scope of protection.

The total amount of CO₂ (including the amount of replenishing CO₂ and that resulting from any recycling) fed to the gasification reactor compared to the carbon in the analytically determined char, e.g. CHNS, is expressed as CO₂/C weight ratio: advantageously said CO₂/C ratio can be 1, preferably it can be comprised between 1 and 150, more preferably between 10 and 140, still more preferably between 100 and 120.

### As Mentioned, the Gas Leaving the Gasification Reactor (Effluent) is Preferably

partly recycled to the gasification reactor (recycled gas stream): in this case, the recycled gas is preferably passed through a heating system outside the gasification reactor, which heats it up to the predetermined reaction temperature, generally to a temperature comprised between 750° C. and 950° C., preferably between 800° C. and 900° C., even more preferably 850° C., before entering the gasification reactor; and
partly (non-recycled part) sent, first, to a heat recovery unit (gas stream to the heat recovery unit) which cools it down, and then subsequently sent to a separator where it is subjected to a separation step. The above distribution of the effluent flow is without any change in composition.

This cooling in the heat recovery unit of said non-recycled part of the gases leaving the gasification reactor is advantageously carried out by giving up some of its warmth to heat part of the CO₂ gas stream (replenishing CO₂).

The volume ratio between the recycled gas stream to the gasification reactor and the non-recycled gas stream to be separated, possibly after having been sent to the heat recovery unit for cooling, is comprised between 1 and 20, preferably between 2 and 10, more preferably between 2 and 8.

The cooled portion of the gas stream that has left the heat recovery unit is, as mentioned, optionally subjected to a separation to remove CO and possibly H₂ from the other gas products, which generally include unreacted CO₂.

This separation can be carried out by one of the methods known in the art.

For example, a separation method based on physical solvents can be conveniently used, e.g. the Rectisol® method that uses methanol to selectively absorb the CO₂ that is subsequently released. Methods based on selective absorption with alkaline solvents, which chemically bind to CO₂ with relatively weak chemical bonds, can also be used for the purpose (e.g. with solutions of monoethanolamine (MEA) or diethanolamine (DEA) or even diisopropanolamine (DIPA), methyldiethanolamine and diglycolamine (DGA). Mixtures of the alkanolamines described above may sometimes be used. The operating conditions of separation processes are known and extensively described in the literature. Finally, physical methods based on adsorption (Pressure Swing Adsorption) can also be conveniently used as the concentration of CO₂ in the stream to be treated to separate and recycle it is high (>10% vol).

Subsequently, in one embodiment, the (unreacted) carbon dioxide separated as above mentioned is first joined (mixed) with the gases leaving the gasification reactor which are recycled directly, then integrated (mixed) with CO₂ coming from an external source (e.g. fresh replenishing CO₂, CO₂ obtained from the pyrolysis plants or a combination thereof), and then the total CO₂ is heated to a temperature between 800° C. and 1100° C., preferably between 825° C. and 950° C., more preferably between 840° C. and 870° C., and then reintroduced into the reactor.

The heating of the total CO₂ stream can be performed in a heat exchanger using, for example, hot gases e.g. combustion flue gases, or in an alternative arrangement, or with electric resistances, preferably using hot gases.

It is understood that the char treatment process of the present disclosure can be applied to any type of char from pyrolysis of mixed plastic waste having any composition in terms of carbon content and ash/metal content that has been found to be unexpectedly irrelevant for the purpose of the total or substantially total carbon recovery.

This makes the present disclosure very relevant as it can be widely applied, because it can be applied to any type of char produced by the pyrolysis of mixed plastic waste, regardless of its composition and/or the composition of the plastics or the type of process that generated it.

In one embodiment, the pyrolysis process upstream of this char recovery process as defined above by means of gasification is carried out on mixed plastics comprising PET (Poly Ethylene Terephthalate) to an extent of more than 5%, preferably more than 15% even more preferably more than 25% by weight. Part of the PET is in fact converted into CO₂ in the pyrolysis reactor. This CO₂ can be recovered from the gas produced by pyrolysis (by one of the methods known in the art, e.g., use of membranes or amine solutions, etc.) and be used in the gasification reactor (pyrogasifier) for gasifying the CHAR from the pyrolysis reactor in accordance with the above-described treatment method of the present disclosure by using CO₂ as gasifying agent. It is thereby possible to also recover CO₂ as a useful material resulting from the pyrolysis of PET, which would otherwise be eliminated, thus increasing the overall yield of the pyrolysis process of mixed plastic waste as defined above.

According to another method, (inorganic and/or organic) potassium, sodium and/or calcium salts such as carbonate, bicarbonate, acetate, oxalate, etc. may be added to the pyrolysis process of mixed plastic waste or SRM waste originating the char to be subjected to this treatment method; potassium carbonate and bicarbonate are preferred.

In a preferred embodiment, the char that is processed by the process according to the present disclosure is a product of the pyrolysis of mixed plastic waste, or pyrolysis of mixed plastics, carried out by adding potassium carbonate as a pyrolysis dehalogenating agent conveniently added in case halogenated polymers, e.g. PVC (polyvinylchloride), are present in the feedstock to the pyrolysis.

Said salt (potassium carbonate) may be dosed so that the cation is present in the final char from 0.2 mol cation/kg to 2 mol cation/kg, preferably from 0.4 mol cation/kg to 1 mol cation/kg, more preferably 0.5 mol cation/kg.

It should be noted that char from the pyrolysis of mixed plastic waste shows, just simply by TGA analysis, a high material recovery, over 90%, at a temperature of 850° C., whereas the literature reveals that lignite char shows, by TGA analysis at the same temperature, a lower material recovery.

Char from the pyrolysis of mixed plastic waste as defined above is therefore particularly suitable and more advantageous for gasification in the presence of CO₂ than bio char from lignin.

Also, with respect to char from fossil fuel coal, it should be noted that char resulting from the pyrolysis of mixed plastic waste is a different material and more suitable for gasification in the presence of CO₂ than said coal due to milder operating conditions.

It should be noted that the process of the present disclosure is completely different from the one described in the literature of the direct gasification of plastics: as mentioned above, in the pyrolysis process, the plastic material is not converted into CO but into a hydrocarbon mixture of varying composition that can be used as raw material in cracking plants, thus shortening the recycling chain compared to obtaining the syngas obtained from the transformation of all the plastic by direct gasification of plastic.

In the process by the Applicant, on the other hand, only the part of the carbon contained in the char is intended to produce CO: only a small portion of all the carbon in the pyrolysis feedstock, typically less than 10 percent, is found in the residue (char), the remainder, on the other hand, is found in hydrocarbon compounds, which are the main product of pyrolysis and which are used as feed in steam cracking plants. In the Application of the present disclosure, therefore, only the char obtained is subjected to gasification with CO₂ to maximise the material recovery of the pyrolysis process.

As mentioned above, the process of direct gasification of plastics is conceptually different from a pyrolysis process of mixed plastic waste coupled with a gasification process of only the char produced.

The present char treatment method can thus be integrated into a pyrolysis process, under pressure or vacuum, of mixed plastics or mixed plastic waste known in the art, for example as described in ES2389799, WO2013187788.

In the pyrolysis step, a dehalogenation treatment known in the art can also take place by adding-during the heating and temperature maintenance step—a dehalogenating agent, e.g. potassium carbonate, so as to obtain a hydrocarbon residue and/or oil with a reduced, if not even negligible, halogen content, e.g. chlorine, without thereby departing from the scope of the present disclosure.

It is therefore another feature of the present disclosure to provide a process for the thermal and/or catalytic pyrolysis of mixed plastic waste or secondary raw material or from pyrolysis of mixed plastics, comprising a subsequent step of treating the char obtained by said pyrolysis process, as described so far.

In one embodiment, the pyrolysis process of mixed plastics is that described in the pending Application WO2023126824 A1 on behalf of the Applicant and incorporated herein in its entirety by reference. This pyrolysis process involves the steps of
bringing the mixed plastic waste material with a non-constant composition into a pyrolysis reactor to a temperature comprised between 330° C. and 580° C. in the substantial absence of oxygen, and to a pressure between atmospheric pressure and 13 bar,
maintaining said material in said pyrolysis reactor at a temperature comprised between 330° C. and 580° C. for a period sufficient to produce in said pyrolysis reactor at least one effluent in the gaseous state, wherein said pressure is adjustable according to the composition of said substantially plastic material and/or the products of said pyrolysis process;
adjusting the pressure in said pyrolysis reactor as a function of the composition of said substantially plastic material and/or of the products of said pyrolysis process, while maintaining said pressure at a value comprised between the atmospheric pressure and 13 bar a;
partially or completely condensing said effluent in the gaseous state to form at least a fluid comprising hydrocarbons which is in the liquid state at 25° C. and which quantitatively is at least 10% by mass of the mass of material fed,
where the pressure adjustment preferably occurs with respect to the H/C ratio (H/C index) and/or the carbon index of said mixed plastic waste material with a non-constant composition.

### DESCRIPTION OF THE DRAWINGS

FIG. 1 shows a block diagram of the process for treating a char from pyrolysis of mixed plastics according to the present disclosure, integrated into any pyrolysis process of mixed plastics.

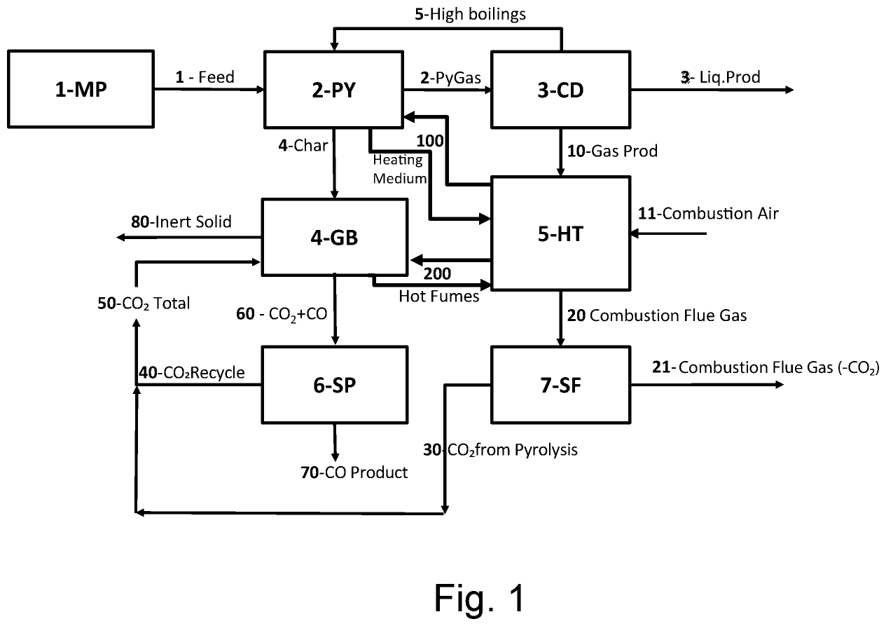

With reference to FIG. 1, an embodiment of the pyrolysis process according to the disclosure will now be illustrated, also comprising a treatment of the relative char according to the disclosure.

The mixed plastic waste, suitably pre-treated by sorting, washing the removal of non-organic solid particles, such as ferrous material and crushed stone, and possibly shredded, is placed in a container (1-MP) and then fed, as stream 1, to the pyrolysis unit (2-PY), which comprises at least one pyrolysis reactor.

The pyrolysis process produces, at the selected pyrolysis temperature, a stream 2 of volatile compounds (Py-gas) and a char 4.

The stream 2 of the volatile compounds (Py-gas) produced is sent to a 3-CD condenser from which they exit:
a stream 3 of liquid compounds (Liq-Prod), which is the main product of pyrolysis mainly consisting of the hydrocarbon oil to be sent subsequently to cracking, and
a gas stream 10 (Prodgas) which will then be advantageously used in the char treatment step according to the present disclosure as it contains CO₂.

The char produced in the pyrolysis of mixed plastic waste is then sent, as stream 4, to the gasifier 4-GB (gasification reactor) described above and subjected to heating at a given temperature, preferably a temperature below 950° C., more preferably below 850° C., in the presence of a stream 50 of CO₂ under the conditions described above so as to produce a resulting gas stream 60 (effluent) comprising CO, unreacted CO₂ and possibly H₂.

The stream 50 of CO₂ which is fed to the gasification reactor 4-GB, comes mainly from the gas stream10 exiting the condenser 3-CD: this stream 10 before entering the gasification reactor 4-GB is used as fuel in a heating system 5-HT outside the gasification reactor 4-GB.

In the heating system 5-HT, a stream of a heating fluid 100 (indicated as “heating means” in FIG. 1) is heated and sent to the pyrolysis unit 2-PY where said fluid stream provides the heat required for the pyrolysis process and from there it returns to the unit 5-HT, in a continuous recirculation, where it is further heated to be sent again to the unit 2-PY; in addition, in the unit 5-HT, as a result of the combustion of stream 10, a stream of very high temperature hot gases 200 is produced (referred to as “hot gases” in FIG. 1), which are sent to unit 4-GB to provide the high-temperature heat required by the pyro-gasification reaction of the char stream 4 produced by pyrolysis.

Said hot flue gases 200, after transferring heat to the pyro gasification unit 4-GB, return to the unit 5-HT where they join the flue gases 20 which provided heat to the heating fluid stream 100 used in the unit 2-PY, and, after cooling with preheating of the combustion air stream 11 used for the combustion of the stream 10 in the unit 5-HT, they are sent to the unit 7-SF for separating CO₂ from the flue gases. In the unit 7-SF, the stream 20 of flue gases is separated into two streams: stream 21 of CO₂-depleted hot gases, which are input into the atmosphere, and stream 30 of CO₂ from pyrolysis.

The stream 30 of CO₂ from pyrolysis is sent to the pyro-gasification unit 4-GB after mixing with the stream 40 of recycled CO₂. In the unit 4-GB where the char stream 4 is also fed, the total stream 50 of CO₂ reacts in the unit 4-GB with the non-inert fraction of the char stream 4 and is transformed into a stream 60 of CO₂+CO which is partly sent to the separator of CO 6-SP and partly recycled inside the unit 4-GB to be fed to the pyro-gasification reactor after having been mixed with the stream 50 of total CO₂ and heated in a heat exchanger (not shown in FIG. 1 because it is inside the unit 4-GB) by means of the hot gases 200 from the unit 5-HT to which they are then sent again after heating the gas stream formed by the stream 50 of total CO₂ and a recycled stream (not shown in FIG. 1 because it is inside the unit 4-GB).

Some illustrative but not limiting examples of the present disclosure are hereinafter described.

### EXAMPLES

The gases used in the following examples were:
—CO₂
Degree of purity: 4.8 (titre >99.9980%)
<5 ppm O₂
<10 ppm N₂
<5 ppm CH₄
<10 ppm H₂O
He (gas chromatograph carrier)
Degree of purity: 5.5 about 99.9995%
about 0.5 ppm O₂
CO+CO₂ absent
<1 ppm N₂
<0.5 ppm H₂
Hydrocarbons absent
<3 ppm H₂O

### Preparation 1: Char from Pyrolysis of Mixed Plastics and Related CHNS Analysis

The char used in the examples of the present Application was prepared as described hereinafter.

A sample of secondary raw material (SRM) of mixed plastic was ground as reported below.

By way of applicable example, without limitation, a secondary raw material SRM from the waste sorting of mixed plastic waste having the composition indicated in Table 1 was used.

As the composition of plastic waste is by nature variable, the compositional range used including the average value is indicated in Table 1. Said secondary raw material complied with UNI 10667-18, to which reference is made for further analytical details: it should be noted that for the purposes of the present disclosure, the composition of the initial plastic mixture is not important since mixed plastic waste do not have a constant and defined composition. Any mixture of mixed plastic waste/scrap can be used, without departing from the scope of the present disclosure.

TABLE 1

% wt.

| Component | min | max | averaged |
|---|---|---|---|
| PE (polyethylene) | 46.9 | 55.7 | 52.0 |
| PP (polypropylene) | 23.1 | 27.4 | 24.0 |
| PS (polystyrene) | 4.3 | 7.1 | 6.0 |
| PET (polyethylene terephthalate) | 4 | 8.5 | 6.5 |
| PVC (polyvinyl chloride) | 0.7 | 1.6 | 1.0 |
| PA (Polyamide) | 1.4 | 1.7 | 1.5 |
| Paper pulp | 3.5 | 6.8 | 5.0 |
| Inerts (ash) | 2.9 | 4.4 | 4.0 |

The SRM was ground in a Retsch ultra-centrifugal mill model ZM 200 using a 2 mm-port grid and setting the rotation speed at 12000 rpm.

The material obtained was used as such and subjected to pyrolysis (described below) without further physical and/or chemical treatments.

25 grams of mixed plastic, obtained as described above, were introduced into a tubular reactor having a diameter of 19 mm and a length of 30 cm. The reactor was then inserted vertically into an electric furnace. The lower end of the reactor was connected to a flow meter through which nitrogen passed, while the upper end was connected to a pressure regulating valve and then to a collection flask equipped with a vent; the vent was connected to a gas meter.

The reactor was subjected to a nitrogen flux of 60 cc/min and heated to 240° C.; once reached 240° C., the nitrogen flow was interrupted and heating to 380° C. and a pressure of 1 bar g was carried out.

Once reached 380° C., the reactor was kept under these conditions for 3 hours.

After 3 hours, the reactor was heated up to 430° C.; once it reached 430° C., the reactor was kept in these conditions for 3 hours.

After 3 hours, the reactor was heated up to 480° C.; once it reached 480° C., the reactor was kept in these conditions until the production of volatile materials (gases) was no longer observed, i.e. for 3 hours.

After 3 hours, the reactor was gradually brought down to atmospheric pressure and started to cool to room temperature by flushing nitrogen again at 60 cc/min.

Once reached the room temperature, the reactor was disconnected and opened; the recovered residue was the char obtained from the pyrolysis of SRM.

The pyrolysis operation described above was repeated several times until several char samples were obtained for a total amount of sufficient char (10 grams) to carry out the experiment.

The various char samples obtained were then mixed to obtain the char sample used in the experimental part of the present Application, which was subjected to elemental analysis (CHNS); the results are summarised in Table 2.

TABLE 2

| | | | | O | Ash |
|---|---|---|---|---|---|
| | | | | (by | (in a muffle furnace |
| C | H | N | S | difference) | at 750 C. °) |
| wt. % | wt. % | wt. % | wt. % | wt. % | wt. % |
| 55 | 2.6 | 0.8 | 0.2 | 9.4 | 32 |

The elemental analysis (CHNS) was carried out using an Organic Elemental Analyzer instrument, brand name “Elementar” mod. “Unicube”.

It should be understood that other elemental analysers may be used without departing from the scope of the present disclosure.

Before carrying out the analysis, the char sample was dried in an oven at a temperature of 110° C. in order to remove any traces of water therein.

2 mg±0.2 of sample and 2 mg±0.2 of WO3 (required by the analytical technique of the instrument) are placed inside the sample holder and introduced into the combustion reactor of the instrument.

The procedure of heating the instrument to 1100° C. is then started; at the end of the cycle, after cooling, the instrument directly provides the % of C, H, N, S in the sample.

Ash was instead determined according to the following gravimetric procedure:

Approximately 1 g of a char sample previously dried in an oven at a temperature of 110° C. and precisely weighed, was placed in a ceramic crucible. Before carrying out this analysis, the crucibles were dried in a muffle furnace at a temperature of 650° C. for three hours and once cooled, they were weighed.

Next, the crucible containing the char sample was placed in a muffle furnace in the presence of air and heated up to a temperature of 750° C. and, once reached this temperature, the system was maintained as such for 3 hours.

At the end of three hours, the crucible was removed from the muffle furnace and placed in a desiccator until it cooled to room temperature and then weighed again.

The percentage of ash present within the char sample and shown in Table 2 was determined through the relationship:

$$\% ash = [ ( A - B ) / C ] \times 100$$

where:
A: is the mass of the crucible with ash, expressed in grams;
B: is the mass of the crucible, expressed in grams;
C: is the mass of the sample examined, expressed in grams.

The oxygen reported in Table 2 was instead calculated by difference according to the following relationship: % O=100−(% C+% H+% N+% S+% Ash) Metals in the char sample were determined using
a microwave mineraliser (for metal analysis), model ETHOS UP from Milestone (conditions: power 1800 W, temperature 210° C., time 35 minutes): the char sample was broken down using a solution consisting of aqua regia (HCl:HNO₃ 3:1), hydrogen peroxide and hydrofluoric acid in a microwave digester Ethos UP;
a spectroscope MPAES Microwave Plasma Atomic Emission Spectroscopy (for metal analysis), model 42-10 MP-AES from Agilent Technologies.

The metal analysis yielded the following results reported in Table 3.

TABLE 3

| Metal | Amount (g/kg char) |
|---|---|
| Ca | 59.8 |
| Ti | 32.9 |
| Al | 22.4 |
| Na | 12.2 |
| Fe | 6 |
| Mg | 5.5 |
| K | 4.3 |
| Ni | 0.4 |
| Cu | 0.4 |
| Sr | 0.4 |
| Cr | 0.4 |
| Mo | 0.3 |
| Zr | 0.2 |
| Mn | 0.1 |

The pyrolysis method described above represents only one example for obtaining char and is in no way limiting to the present disclosure; any pyrolysis method, known to the skilled in the art, can in fact be used for the production of char from pyrolysis of mixed plastics.

### Examples 1-4 of Char Analysis Using TGA

### Example 1: TGA of Char at 750° C. In the Presence of Carbon Dioxide

A char sample from the pyrolysis of plastics as described in Preparation 1 was subjected to thermogravimetric analysis TGA in the presence of carbon dioxide.

The instrument used is a TA Instrument Q 500 V20. Approximately 10 mg of a precisely weighed sample were placed in the crucible of the instrument and subjected to heating according to the following method provided by the TGA analytical method:
1—Fluxed gas: CO₂ at a flow rate of 60 ml/min
2—Heating to 40° C.
3—Stop for 5 minutes at 40° C.
4—Heating to 750° C. at a rate of 10° C./min
5—Isotherm at 750° C. for 360 minutes
6—After 360 minutes, replacing CO₂ gas with nitrogen at the same flow rate and cooling to 50° C. at a rate of 50° C./min
7—Isotherm at 50° C. for 40 minutes and end of analysis.

The final residue of the sample after carbon dioxide flow analysis was 33% by weight relative to the initial char sample weight.

The TGA analysis at 750° C. with CO₂ fluxing shows a residue (33%) fully comparable to the ash content in the char obtained by elemental analysis and calculation of the % of ash (32%, using the crucible method): this shows a reaction of CO₂ with the mass of char remaining to reach 100 (67%), confirming the complete gasification of carbon in the char from pyrolysis of mixed plastic waste.

### Example 2: TGA of Char at 800° C. In the Presence of Carbon Dioxide

In the Example 2, the same char and the same instrument as described in the example 1 was used.

Approximately 10 mg of a precisely weighed sample were placed in the crucible of the instrument and subjected to heating according to the method described above in Example 1 but at a higher T and for a shorter time, as reported below:
1—Fluxed gas: CO₂ at a flow rate of 60 ml/min
2—Heating to 40° C.
3—Stop for 5 minutes at 40° C.
4—Heating to 800° C. at a rate of 10° C./min
5—Isotherm at 800° C. for 200 minutes
6—After 200 minutes, replacing CO₂ gas with nitrogen at the same flow rate and cooling to 50° C. at a rate of 50° C./min
7—Isotherm at 50° C. for 40 minutes and end of analysis.

The final residue of the sample after carbon dioxide flow analysis was 32.1% by weight relative to the initial char sample weight. The TGA analysis with CO₂ fluxing shows a residue (32.1%) fully comparable to the ash content (33%) in the char obtained by elemental analysis and calculation of the % of ash (using the crucible method): this shows a reaction of the remaining mass with CO₂, confirming the complete gasification of the carbon in the char from pyrolysis of mixed plastic waste that is not contained in the ash.

### Example 3: TGA of Char at 700° C. In the Presence of Carbon Dioxide

In the Example 3, the same char and the same instrument as described in the Example 1 was used.

Approximately 10 mg of a precisely weighed sample were placed in the crucible of the instrument and heated according to the method described above in Example 1 but at a lower T, as reported below:
1—Fluxed gas: CO₂ at a flow rate of 60 ml/min
2—Heating to 40° C.
3—Stop for 5 minutes at 40° C.
4—Heating to 700° C. at a rate of 10° C./min
5—Isotherm at 700° C. for 360 minutes
6—After 360 minutes, replacing CO₂ gas with nitrogen and cooling to 50° C. at a rate of 50° C./min
7—Isotherm at 50° C. for 40 minutes and end of analysis.

The final residue of the sample after carbon dioxide flow analysis was 36.8% by weight relative to the initial char sample weight.

The analysis shows a residue (36.8%) slightly higher than the ash content (33%) in the char obtained by elemental analysis and calculation of the % of ash (crucible method at 750° C.) but still with an evident reaction between the mass remaining to reach 100 (63.2%) and CO₂.

### Example 4 (Comparative): TGA of Char at 920° C. In the Presence of N₂ and at 850° C. In the Presence of Air

In Example 4, the same char and the same instrument as described in Example 1 was used. On this occasion, however, the analysis was firstly performed in the presence of nitrogen and then in the presence of air, heating the sample to 920° C. as per the method below:
1-Fluxed gas: N₂ at a flow rate of 60 ml/min
2—Heating to 40° C.
3—Stop for 5 minutes at 40° C.
4—Heating to 920° C. at a rate of 10° C./min
5—Isotherm at 920° C. for 10 minutes
6—Cooling to 400° C. at a rate of 20° C./min
7—Isotherm at 400° C. for 5 minutes
8 Replacing N₂ with air at a flow rate of 60 ml/min
9—Heating to 850° C. at a rate of 20° C./min
10—Isotherm at 850° C. for 5 minutes
11—After 5 minutes, replacing the air gas with nitrogen at the same flow rate and cooling to 50° C. at a rate of 50° C./min
12—Isotherm at 50° C. for 40 minutes and end of analysis.

The analysis thus performed shows that the char in an inert environment (fluxing with N₂) has an initial mass loss of approximately 24% due to heating alone. This loss is attributable to heavy compounds that undergo evaporation/degradation when heated up to 920° C.

Replacing the nitrogen with air then results in the combustion of carbon; at 850° C., there is a final residue of about 31.4%, a value comparable to the value (33%) of the ash in the char determined by calculating the % of ash after the crucible procedure.

The tests carried out in Examples 1 to 3 hence highlight the reactivity of CO₂ with the carbon present in the char.

### Examples 5-10 of Char Gasification

### Example 5: Gasification at 750° C. Of Char from Pyrolysis of SRM of Mixed Plastics with CO Production

The char from Example 1 was subjected to reaction with CO₂ in a tubular reactor in a small laboratory set-up as described below:

### Reactor Material: Quartz

The reactor had an inner diameter of 10 mm and a length of 200; a quartz wool septum was inserted about halfway down the tube. The reactor was housed in a cylindrical electric furnace equipped with control thermocouples. The lower end of the reactor was connected to a flow meter and controller, brand name Brooks model 5850 Series, for feeding the CO₂.

Instead, the reactor outlet was connected to a gas chromatograph for the analysis of outflow gases. The instrument used was:

Agilent Technologies Gas chromatograph, Model: GC1540A equipped with Porapak N columns (2.5 m long) and Molecular sieves (length: 5 m).

### Gas Analysis Conditions:

Head flow pressure: 63 psi; Ramp: 35° C.×0.7 min, rising to 75° C. in one minute; stop at 75° C. for 4 minutes; cooling to 50° C. up to 35° C.; stop at 35° C. for 2.2 minutes. Carrier: Helium (He)

Approximately 100 mg of char from Example 1, precisely weighed, were loaded into the reactor described above (placed on the quartz wool septum) and heated under a flow of 20 Nml/min CO₂ from room temperature to 700° C. at a rate of 10° C./min; once reached 700° C., heating was continued up to 750° C. at a rate of 5° C./min.

The reactor was kept at 750° C. and subsequently cooled after 260 min calculated from the start of heating. Cooling to room temperature was carried out by replacing the flow of CO₂ with an equal flow of N₂. Therefore, CO₂ was fed to the reactor for 260 minutes for a total of 5.2 litres.

The analysis of the gas leaving the reactor was analysed by the aforementioned analyser (gas chromatograph), in line during the reaction, showing a maximum CO concentration in CO₂ of 20% (vol/vol), the part remaining to reach 100% by volume consisting of CO₂.

The conversion of carbon into char, as determined by the report below, was 93% by weight.

$$( 1 - \frac{B - A \cdot \% Ash}{A - A \cdot \% Ash} ) \cdot 100 ,$$

### Where:

A is the weight of the char sample loaded into the reactor
B is the final weight of char residue left in the reactor
% Ash is the percentage of ash contained in the char sample determined as above by gravimetry in a muffle furnace at 750° C. (32%)

### Example 6: Gasification at 750° C. Of Char from Pyrolysis of SRM of Mixed Plastics with CO Production

Example 6 was carried out under the exact same conditions and with the same apparatus as Example 5, but using a different type of waste plastic char found on the market as fuel and called “Pyrolysis Char Neoliquid” supplied by the company—Neoliquid Advanced Biofuels and Biochemicals-Guadalajara (SPAIN).

The char was subjected to analysis as described above (CHSN and combustion in a muffle furnace at 750° C. for ash determination) and gave the results shown in Table 4:

TABLE 4

| | | | | O | Ash |
|---|---|---|---|---|---|
| | | | | (by | (in a muffle furnace |
| C | H | N | S | difference) | at 750° C.) |
| wt. % | wt. % | wt. % | wt. % | wt. % | wt. % |
| 52.4 | 3.7 | 2.6 | 0.4 | 6.4 | 34.5 |

The gas leaving the reactor was analysed by the in-line analyser showing a maximum CO concentration in CO₂ of 12% (vol/vol), the part remaining to reach 100% by volume consisting of CO₂.

After having carried out the gasification, the carbon conversion was determined using the same method as described in Example 5 which was found to be 90%.

### Example 7: Gasification at 750° C. Of Char from Pyrolysis of SRM of Mixed Plastics with CO Production

Example 7 was carried out under exactly the same conditions and with the same apparatus as in Example 5.

The char that was used was instead obtained by Preparation 1, using a SRM with the composition of Table 1 to which, however, 20% by weight of PET (polyethylene terephthalate) was added.

The char obtained was analysed as described above (CHNS and combustion in a muffle furnace at 750° C. for ash determination) and the composition shown in Table 5.

From the composition shown, it can be seen that the percentage of O₂ contained in the char from pyrolysis of mixed plastics containing PET is no higher than the other types of char previously used; this is an indication of the fact that PET already decomposes during pyrolysis, releasing CO₂.

TABLE 5

| | | | | O | Ash |
|---|---|---|---|---|---|
| | | | | (by | (in a muffle furnace |
| C | H | N | S | difference) | at 750 C. °) |
| wt. % | wt. % | wt. % | wt. % | wt. % | wt. % |
| 65.4 | 2.2 | 0.9 | 0.3 | 4.2 | 27 |

The analysis of the gas leaving the reactor was analysed by the in-line analyser showing a maximum CO concentration in CO₂ of 16% (vol/vol).

After having carried out the gasification, the carbon conversion was determined using the same method as described in Example 5 which was found to be 90%.

### Example 8: Gasification at 750° C. Of Char from Pyrolysis of SRM of Mixed Plastics with CO Production

Example 8 was carried out under exactly the same conditions and with the same apparatus as in example 5.

The char that was used was instead obtained by Preparation 1, using a SRM with the composition of Table 1 to which, however, 7% by weight of Potassium Carbonate was added.

The char obtained was analysed as previously described (CHNS and combustion in a muffle furnace at 750° C. for ash determination) and the composition indicated in Table 6.

TABLE 6

| | | | | O | Ash |
|---|---|---|---|---|---|
| | | | | (by | (in a muffle furnace |
| C | H | N | S | difference) | at 750° C.) |
| wt. % | wt. % | wt. % | wt. % | wt. % | wt. % |
| 35.8 | 1.8 | 0.7 | 0.4 | 2.4 | 57.7 |

The analysis of the gas leaving the reactor was carried out by the in-line analyser showing a maximum CO concentration in CO₂ of 22% (vol/vol), the part remaining to reach 100% by volume consisting of CO₂.

After having carried out the gasification, the carbon conversion was determined using the same method as described in Example 5 which was found to be 99.9%.

### Example 9: Gasification at 700° C. Of Char from Pyrolysis of SRM of Mixed Plastics with CO Production

Example 9 was carried out under the same conditions as Example 8 except for the reaction temperature.

The reactor was heated from room temperature to 650° C. at a rate of 10° C./min; once reached 650° C., heating continued to 700° C. at a rate of 5° C./min. The reactor was kept at 700° C. and cooled after 260 min calculated from the start of heating. Cooling to room temperature was carried out by replacing the flow of CO₂ with an equal flow of N₂. Therefore, CO₂ was fed to the reactor for 260 minutes for a total of 5.2 litres.

The gas leaving the reactor was analysed by the in-line analyser showing a maximum CO concentration in CO₂ of 20% (vol/vol), the part remaining to reach 100% by volume consisting of CO₂.

After having carried out the gasification, the carbon conversion was determined using the same method as described in Example 5 which was found to be 93%.

Examples 5 to 9 show how high carbon conversions are achieved already at 750° C. and on different char types.

The presence of a potassium salt in the pyrolysis, normally used as a dehalogenating agent, makes it possible to increase the conversion (Example 8) or to lower the gasification temperature to 700° C. (Example 9 in comparison with Example 5).

### Example 10: Gasification at 750° C. Of Char from Pyrolysis of Mixed Plastic SRM

In order to simulate the recycling step of the CO containing reaction gas, Example 10 was carried out under the same conditions, operating mode and equipment as Example 5, except that the char was heated under a flow of 20 Nml/min of a 16.26% vol. mixture of CO in CO₂ (supplier SIAD) instead of CO₂.

Therefore, CO₂ was fed to the reactor for 260 minutes for a total of 4.355 Nlitres and CO was fed for a total of 0.845 Nlitres.

The gas leaving the reactor was subjected to analysis as in the previous examples. The maximum value of CO produced was 17% by volume calculated by subtracting the CO present in the feeding.

The conversion of carbon into char under these conditions was 91%.

Comparing the conversion data of Example 5 with those of Example 10, it can be seen that the values are substantially similar: it results that even when operating with a mixture of CO₂ and CO, rather than just CO₂, there is no substantial reduction in the conversion of the carbon contained in the char into CO under the operating conditions of the present method: this is despite the fact that the CO formation reaction is an equilibrium reaction

Therefore, it is possible to recycle into the reactor the gases leaving the gasification reactor.

TABLE 7

| | | | Residence | Total of CO₂ | CO | Ash | Conversion |
|---|---|---|---|---|---|---|---|
| | | T | time | fed | produced | (% w/w initial | carbon |
| Example | Type of char | (° C.) | (minutes) | (litres) | (% volume) | char) | (%) |
| 5 | Ex. 1 | 750 | 260 | 5.2 | 20 | 33 | 93 |
| 6 | Commercial | 750 | 260 | 5.2 | 12 | 34.5 | 90 |
| 7 | Ex. 1 with | 750 | 260 | 5.2 | 16 | 27 | 90 |
| | PET | | | | | | |
| 8 | Ex. 1 with | 750 | 260 | 5.2 | 22 | 57.7 | 99.9 |
| | K₂CO₃ | | | | | | |
| 9 | Ex. 1 with | 700 | 260 | 5.2 | 20 | 57.7 | 93 |
| | K₂CO₃ | | | | | | |
| 10 | Ex. 1 | 750 | 260 | 5.2 (mix | 17 | 33 | 91 |
| | | | | at 16.26 | | | |
| | | | | % Vol | | | |
| | | | | of CO) | | | |

1. A process for recovering carbon contained in a char (solid carbonaceous residue) from pyrolysis of mixed plastic waste or secondary raw material which is the end product of the recycling and/or treatment of plastic wastes, or a char from pyrolysis of mixed plastics, through the production of CO, and optionally synthesis gas, said process including the following steps:
(A) heating said char in a gasification reactor and in the presence of carbon dioxide to reach a prefixed temperature comprised in a range lower than 950° C. and higher than 600° C.;
(B) continue heating said char in said temperature range, in the presence of CO₂, for a prefixed residence time of said char in said reactor producing an outflow gas stream (effluent) comprising CO in addition to unreacted CO₂, and possibly H₂, and
(C) sending at least a part of the gas stream (effluent) leaving the reactor comprising CO, unreacted CO₂, and optionally H₂, to at least one subsequent operating unit selected from a unit for separating CO from CO₂, a direct use unit of said outflow stream or to a storage unit.

2. The process according to claim 1, wherein the char to be subjected to steps (A), (B) of the process is a char resulting from a pyrolysis process of mixed plastic waste or of said secondary raw material obtained from the recycling and/or treatment of plastic wastes.

3. The process according to claim 1, wherein, in said step (C), only a part of the gas stream leaving the reactor and containing CO and unreacted CO₂ is sent to at least one subsequent unit for separating CO from CO₂, recycling the remaining part of the gas stream leaving the reactor to the gasification reactor, optionally supplemented with fresh replenishing CO₂.

4. The process according to claim 1, wherein the CO₂ in the gasification reactor in step (A) is not pure and is contained in a gas stream containing CO₂ in a predominant amount with respect to other gases contained in said stream.

5. The process according to claim 1, wherein the gasification reactor comprises a horizontal cylinder, equipped with stirring/mixing/moving means and/or a fluidization system, for promoting the contact of all solid mass (char) with the carbon dioxide.

6. The process according to claim 5, wherein said stirring/mixing/moving means are in the form of a screw.

7. The process according to claim 1, wherein the heating temperature of said char in the gasification reactor in said phase (A) and/or (B) is between 700° C. and 950° C.

8. The process according to claim 1, wherein the total char gasification reaction pressure is from 0.2 bar (a) to 1.5 bar (a).

9. The process according to claim 1, wherein the residence time of the char in the gasification reactor is from 0.5 to 10 hours.

10. The process according to claim 1, wherein the total quantity of CO₂ fed to the gasification reactor with respect to the carbon in the char determined via analysis, expressed as CO₂/C weight ratio, is from 1 to 150.

11. The process according to claim 2, wherein said part to be recycled of said gas leaving the gasification reactor (effluent) is passed through a heating system outside the gasification reactor which heats said gas it-up to a predetermined reaction temperature before entering the gasification reactor.

12. The process according to claim 2, wherein said non-recycled part of said gas leaving the gasification reactor (effluent) is sent to a heat recovery unit which cools said gas it before being subjected to the separation step.

13. The process according to claim 1, wherein the volume ratio between the recycled stream of the gasification reactor and the non-recycled stream to be subjected to separation is from 1 to 20.

14. A thermal and/or catalytic pyrolysis process of mixed plastics or secondary raw material which is the end product of the recycling and/or treatment of plastic wastes, or from mixed plastics pyrolysis, further comprising a treatment of the char obtained from said pyrolysis process by the organic carbon recovery process as defined in claim 1.
